(19) United States
(12) Patent Application Publication
(10) Pub. No.: US 2025/0036979 A1
(43) Pub. Date: Jan. 30, 2025

(54) ACTIVITY PLANNER

(71) Applicant: Arm Limited, Cambridge (GB)

(72) Inventors: Remy Pottier, Grenoble (FR); Vasileios Laganakos, Saffron Walden (GB); Diya Soubra, Nice (FR); Nicholas John Cook, Kenilworth (GB)

(73) Assignee: Arm Limited, Cambridge (GB)

(21) Appl. No.: 18/523,411

(22) Filed: Nov. 29, 2023

(30) Foreign Application Priority Data
Jul. 27, 2023 (EP) 23386070.9

(51) Int. Cl. G06N 5/046; G06N 5/022

(52) U.S. Cl. CPC G06N 5/046; G06N 5/022

(57) ABSTRACT

A machine learning and inferencing system to generate a personalised activity plan comprises a trained world context knowledge base; a trained personal digital memory store; a goal engine to establish an activity goal; an activity decomposition engine to decompose an activity into a logically-consistent sub-activities connected by; a ponderation engine to assign value weights to potential sub-activities; a graph generation engine to generate a multi-layer weighted graph to train a model of personalised outcomes of the sub-activities according to the value weights; a scenario generation engine to analyze the network of logically-consistent potential sub-activities connected by paths to determine a selected scenario path to the activity goal according to at least the model of personalised user outcomes; a feedback engine to apply learning from the scenario generation engine to the world context knowledge base and/or the personal digital memory store; and an output channel to output a personalised activity plan comprising recommended actions to implement the selected scenario path.

The present technology relates to a machine learning and inferencing system capable of planning activities, and more particularly to the provision of machine learning technologies capable of planning activities that are personalised according to a knowledge of the real-world context and the personal tastes of the user.

The use of technology to plan human activities in a logically-consistent and practically implementable manner is difficult. The planning space is typically complex, multifactorial, situational, history based and personal, and thus extremely difficult to approach using known techniques, such as generative AI with large language models or known personal digital assistants, which are little more than conversational bots.

In a first approach to the many difficulties encountered in addressing the issue of the provision of machine learning technologies capable of planning activities, the present technology provides a machine learning and inferencing system operable to generate a personalised activity plan comprising: a trained world context knowledge base; a trained personal digital memory store comprising personal affect values for a user; a goal engine to establish at least one activity goal derived from an input activity descriptor; an activity decomposition engine co-operable with the world context knowledge base and the personal digital memory store to decompose an activity into a network of logically-consistent potential sub-activities connected by paths converging at the activity goal; a ponderation engine co-operable with the world context knowledge base and the personal digital memory store to assign fact-based and personal affect value weights to the logically-consistent potential sub-activities according to a value scheme derived from the world context knowledge base and the personal digital memory store; a graph generation engine responsive to the activity decomposition engine and the ponderation engine to generate a multi-layer graph operable to train a model of personalised user outcomes of the sub-activities according to the fact-based and personal affect value weights; a scenario generation engine co-operable with the graph generation engine to analyze the network of logically-consistent potential sub-activities connected by paths to determine a selected scenario path to the activity goal according to at least the model of personalised user outcomes; a feedback engine to apply learning from the scenario generation engine to the world context knowledge base and/or the personal digital memory store; and an output channel to output a personalised activity plan comprising recommended actions to implement the selected scenario path.

In a second approach, the present technology provides a method of operating a machine learning and inferencing system operable to generate a personalised activity plan comprising: establishing at least one activity goal derived from an input activity descriptor; operating an activity decomposition engine co-operable with a trained world context knowledge base and a trained personal digital memory store comprising personal affect values for a user to decompose an activity into a network of logically-consistent potential sub-activities connected by paths converging at the activity goal; operating a ponderation engine co-operable with the world context knowledge base and the personal digital memory store to assign fact-based and personal affect value weights to the logically-consistent potential sub-activities according to a value scheme derived from the world context knowledge base and the personal digital memory store; generating, by a graph generation engine responsive to the activity decomposition engine and the ponderation engine, a multi-layer weighted graph operable to train a model of personalised user outcomes of the sub-activities according to the fact-based and personal affect value weights; operating a scenario generation engine co-operable with the graph generation engine to analyze the network of logically-consistent potential sub-activities connected by paths to determine a selected scenario path to the activity goal according to at least the model of personalised user outcomes; operating a feedback engine to apply learning from the scenario generation engine to the world context knowledge base and/or the personal digital memory store; and emitting, by way of an output channel, a personalised activity plan comprising recommended actions to implement the selected scenario path.

The method may be computer-implemented, for example in the form of a computer program product that, when loaded into a computer system and executed, causes the computer system to perform the method according to the claims.

Implementations of the disclosed technology will now be described, by way of example only, with reference to the accompanying drawings, in which:

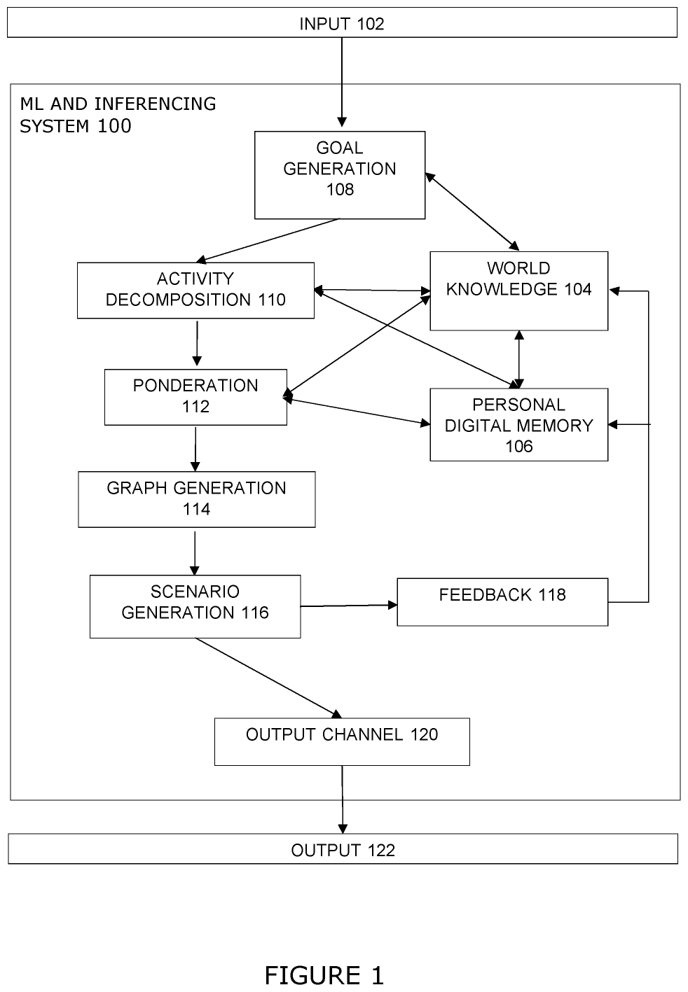

FIG. 1 shows a simplified view of a machine learning and inferencing system capable of planning activities that are personalised according to a knowledge of the real-world context and the personal tastes of the user, according to an implementation of the presently described technology;

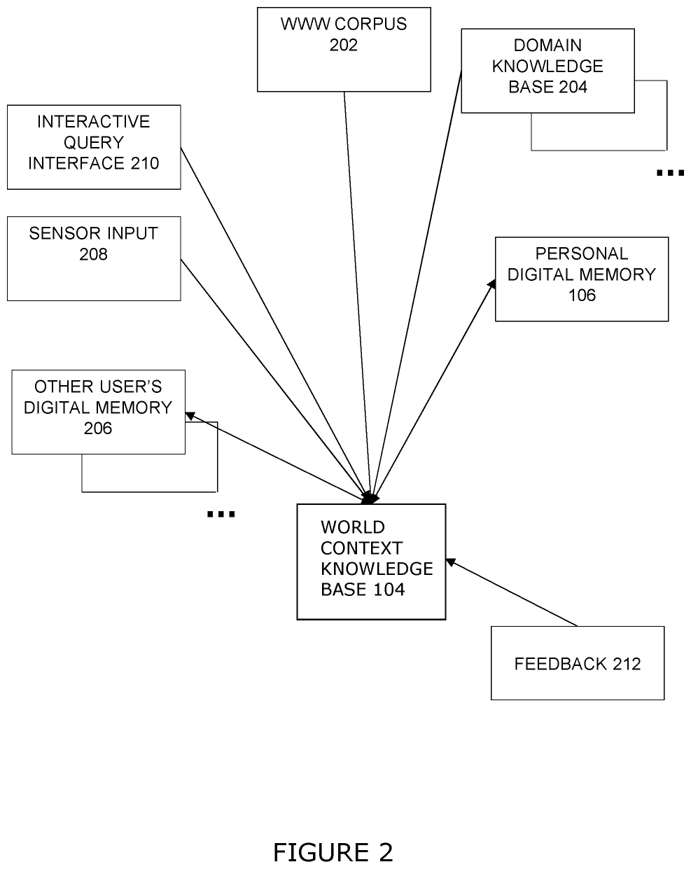

FIG. 2 shows a simplified representation of a world context knowledge acquisition arrangement, according to an implementation of the presently described technology; and

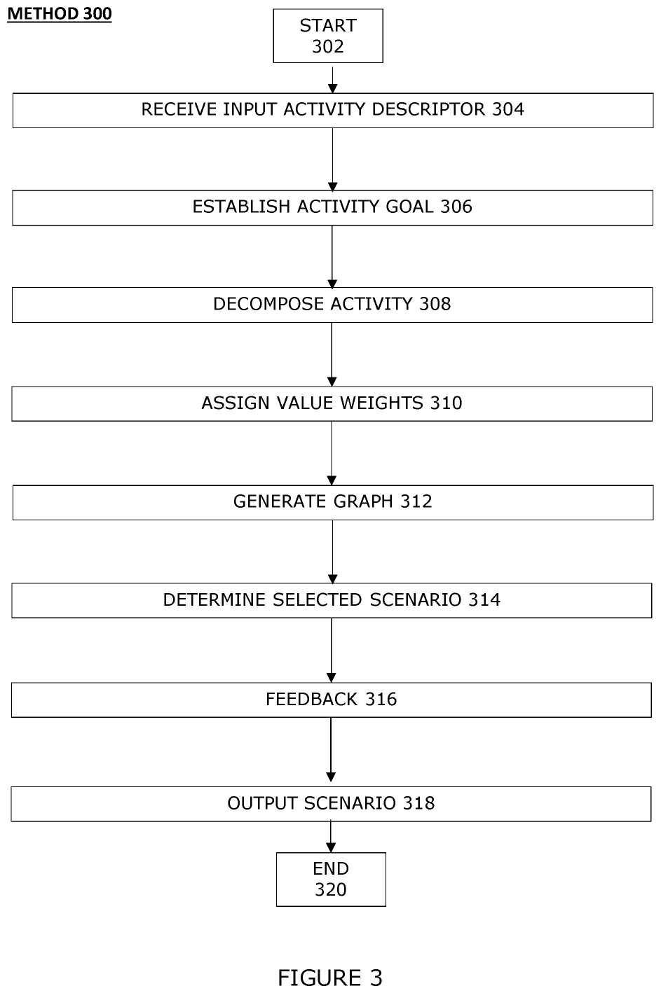

FIG. 3 shows a simplified representation of a method operating a machine learning and inferencing system operable to generate a personalised activity plan according to an implementation of the present technology.

As described above, it is desirable to have a machine learning and inferencing technology that is capable of defining a planning space (using general and personal knowledge) and developing logically-consistent and implementable plans. The planning space is typically complex, multifactorial, situational, history-based and personal, and for this reason, the technology required involves a number of different machine learning and inferencing engines, most effectively including appropriately selected artificial neural networks, to be effective.

The present technology thus provides a system, apparatus, computer-implemented techniques and electronic logic for a machine learning and inferencing system capable of planning activities that are personalised according to a knowledge of the real-world context and the personal tastes and emotional responses of the user.

To achieve this requires a modular machine learning and inferencing architecture including the capability:
to interpret and understand an activity in terms of one or more goals;
to acquire and exploit general and domain knowledge and personal knowledge of the user;
to define a problem search space between a start state and a goal;
to estimate intervening states in the problem space and decompose the start to goal paths into solvable sub-activities;
to predict future sub-activity states along the paths;
to re-aggregate sets of sub-activities into plausible scenarios;
to use contextual and personal knowledge to apply weightings to entities and actions comprised in the scenarios;
to balance the overall weightings to rank scenarios with a view to select a best available outcome according to context and personal knowledge;
to present the outcome for action; and
to feed back the findings at each stage of the process to enable continuous machine learning in an evolving technology.

A machine learning and inferencing system according to the present technology may be implemented so that the world context knowledge base comprises at least one specific domain knowledge base-such as a gazetteer of locations, for example, restaurants and hotels, along with details of their available facilities. In another example there may be a knowledge base containing dates of public holidays for various jurisdictions, religious festivals, and the like information that may be useful in planning events. The world context knowledge base may comprise an active database that is operable to detect at least one anomaly in its stored information-such a discrepancy between two asserted facts—and to query at least one data source for additional data to attempt to resolve the anomaly. In one implementation, the data source query operation comprises using a joint embedding predictive architecture. In an environment in which there exist a plurality of world context knowledge bases, the world context knowledge base according to the present technology is operable to query a peer world context knowledge system to acquire additional knowledge. In another implementation, the personal digital memory store of the machine learning and inferencing system may be operable to query a peer digital memory store to acquire additional knowledge.

As will be clear to one of ordinary skill in the art, the present technology is operable in various computing-enabled environments and computing entities, including, for example, conventional distributed processing environments of multiple cooperating servers, as well as cloud computing environments and the Metaverse, where it may combine with other technologies in the hyperpersonalization of computing.

“Computing entity,” as used in the present description may refer to a hardware device, which may be reconfigurable as needed, or to a firmware or software entity, which may be installed on a hardware device, or which may comprise distributed processing elements installed on plural devices. For example, a computing entity may comprise a virtual machine established on an infrastructure, such as a cloud computing infrastructure. Computing entities of the present technology may include artificial neural networks, which may take the form of convolutional neural networks, recurrent neural networks, long short-term memory networks and the like.

Computing entities that may benefit from the present technology are network-attachable, that is, they are provided with the means to attach to communications networks either in the form of a static attachment, via cable, or in the form of wireless attachments. In one example, a wirelessly networked computing entity may be intermittently attachable to a Bluetooth® network, or it may be attachable via a WiFi® network. As will be clear to one of ordinary skill in the art, various other forms of static and intermittent network attachment may be equally advantageously used with the present technology.

The term “affect” as used in the present disclosure is a term of art from the psychological sciences—that is, “the pleasantness or unpleasantness, or a complex of ideas involved in, an emotional state. An affect value may thus comprise the positive or negative emotional reactions of a user associated with a fact or situation, an object, event, person or location. For the purposes of the present technology, affect values may be stored in a personal digital memory in association with fact-based data entities, and they may take the form of values on, for example, a scale from “least liked” to “most liked” where the values are represented numerically from, for example, 0 to 10. They may instead be stored simply in a binary form as “liked”=1 and “disliked”=0. In whatever form they are stored, in the present technology they may be used as weighting factors for the facts associated with the activities and sub-activities that form the graph from a start state to a goal state.

The term “ponderation” is used to mean “the application of a numerical measurement to an entity to assign a weight or value to that entity”. The corollary term “ponderation engine” has been used here with the specialised meaning of “a machine learning and inferencing engine capable of deriving factual and affect-based weightings for objects and events and representing those weightings according to a relative weighting schema”.

Turning now to FIG. 1, there is shown a simplified view of a machine learning and inferencing system 100 capable of planning activities that are personalised according to at least a knowledge of the real-world context and the personal tastes of the user, according to an implementation of the presently described technology.

The machine learning and inferencing system may be implemented, at least in part, using deep learning technologies operable in neural networks, and these technologies may be augmented by the use of rule-based systems, conventional expert systems, and the like.

The machine learning and inferencing system 100 receives input 102 defining an activity to be planned. The input may be in the form of a natural language request, or it may be arranged in a formal construct suited to machine analysis. If the input 102 defining the activity to be planned is in the form of a natural language request, a natural language processor is required to render the natural language request into a format in which it can be further processed.

Whether to input is in the form of a natural language request or arranged in a formal construct, a goal generation engine 108 parses the input to redefine the activity in terms of one or more goals to be achieved, using, for example, information from a world context knowledge base 104.

World context knowledge base 104 may comprise a trained expert system augmented by supervised or quasi-supervised machine learning. In one example, world context knowledge base 104 may comprise a semantic web derived from plural bodies of knowledge, including those accessible via the World Wide Web. World context knowledge base 104 may further comprise knowledge derived from sensor input, from specific domain knowledge bases and from autonomous or guided learning using an interactive query interface. In one specific example relating to the goal generation engine 108, world context knowledge base 104 may comprise one or more relational arrangements linking natural language descriptions of activities with inferentially-derived definitions of goals. World context knowledge base 104 may be implemented with active data store capabilities—that is, it may be operable to actively seek and acquire information to add to its available context knowledge, and it may be operable to adapt and modify previously stored knowledge and relationships in light of new data acquisitions. This active seeking may be implemented by, for example, the detection of gaps in a semantic web, or in another example, by detecting contradictions and/or classification anomalies in the world context knowledge base 104.

World context knowledge base 104 may further comprise knowledge of the context of the proposed activity, including a starting state from which the proposed activity will begin. This knowledge of the starting state may be derived, for example, from a natural language description of the planned activity, from an interactive query interface, from a corpus of knowledge derived from the world wide web, from sensor data and/or from information held in a personal digital memory 106 (see below). In one implementation, knowledge may be acquired by using a joint embedding predictive architecture to provide self-supervised learning from image data, and the knowledge thus acquired may be incorporated into the world context knowledge base 104 along with the data derived from other sources, such as textual and semantic knowledge of the type used and manipulated by large language model artificial intelligence computing entities. Further, the world context knowledge base for a first user may be in electronic communication with a peer system for a second or further user to request permission and then interrogate the second user's personal digital memory to acquire information about the second user's knowledge of a particular person, object, event or location, based on the second user's stored personal digital memory (for more on personal digital memories, see below).

As will be immediately clear to one of ordinary skill in the art, however, the above-described scheme for the world context knowledge base 104 to autonomously seek and acquire new contextual knowledge from external knowledge-based resources, from peer systems or from human informants via the interactive query interface represents a significant advance over the state of the art.

After the goal generation engine 108 has redefined the activity in terms of a goal to be achieved, activity decomposition engine 110 is activated to apply its previous training to the task of inferencing over the goal data and information from world context knowledge base 104 about the starting state described above and about the problem context created by the juxtaposition of the goal and the starting state. Activity decomposition engine 110 is further able to derive information from personal digital memory 106 (see below) to assist in its inferencing task. The inferencing applied to the given data about the goal and starting state is operable to decompose the activity into sets of logically-consistent sub-activities each capable of contributing to progress from the defined starting state to the defined goal. Activity decomposition engine 110 may be implemented using a knowledge-based system in conjunction with a neural network suitable for classification and decision-making, such as a convolutional neural network, a recurrent neural network or a long short-term memory network.

Personal digital memory 106 may comprise a trained expert system augmented by supervised or quasi-supervised machine learning. In one example, personal digital memory 106 may comprise a semantic web derived from information sources relevant to the user—for example, the user's personal contact lists, diaries, social media materials, shopping data, gaming performance data, physical data from a wearable fitness monitoring device, data derived from a brain-computer interface device, and the like. Any data entity in the personal digital memory 106 may be augmented with affect value data recording personal preferences and emotional weightings associated with the data—for example, a value representing likes and dislikes in foodstuffs, vacation destinations, hotel types, and the like. The affect values may further comprise stored representations of emotional responses to objects, events, places, etc. The affect values may be free-standing and static, such as a permanent dislike of foods containing banana, or they may be fully or partially contextualised, such as a preference for hot vacation destinations in January, February and March. The personal digital memory 106 may be implemented using a digital twin technique operable to seek to complete a model person by actively and continuously scanning sources of personal knowledge to maintain an up-to-date schema of data and affect value for the user. In one implementation, personal digital memory 106 is implemented as a digital twin capable of communicating autonomously with peer digital twins over a network to elicit additional knowledge to add to its store—for example, a personal digital memory 106 for a first user may be in electronic communication with a peer personal digital memory for a second or further user to ascertain the second user's affect value for a particular activity or entity, based on the second user's stored preferences and emotional responses.

The personal digital memory 106 may be implemented to store memories in various forms, including as engrams—that is, as logically-related complexes of facts and affect values associated with a person, object, event or location. As an example, an engram may comprise facts about a visit to a location, such as a restaurant (including the menu, dishes selected, price, ambiance of the restaurant, quality of service, number of seats available, and the like), and an indication of the user's responses to that visit (positive and/or negative impressions and emotions associated with any of the facts).

The personal digital memory 106 may be operable to actively seek information to supplement existing data by querying any of the above-described data sources or by interacting with a user. As will be immediately clear to one of ordinary skill in the art, the above-described scheme for the personal digital memory 106 to autonomously seek and acquire new knowledge represents a significant advance over the state of the art. The personal digital memory 106 is operable to function as a digital twin of the user, such that events and scenarios can be modelled and their outcomes examined and assessed without involvement of the user—for example, a scenario involving a dinner party for four named individuals may be modelled using facts such as a specific restaurant, a specific menu etc. to determine whether the user will enjoy the venue, the food and the company, all without the event taking place in real life. This may be done by assembling the facts from the personal digital memory and summing the affect values associated with the elements, such that a judgment can be derived from the summed affect values.

The augmenting of data entities in the personal digital memory 106 may be performed by a ponderation engine 112 which is capable when trained by supervised or quasi-supervised machine learning to associate affect value data relating to personal preferences and emotional weightings. The ponderation engine 112, in combination with the personal digital memory thus forms a dynamic reward engine with the ability to reach out to acquire additional data. The term “ponderation engine” has been used here with the specialised meaning of “a machine learning and inferencing engine capable of deriving factual and affect-based weightings for objects and events and representing those weightings according to a relative weighting schema”. The ponderation engine 112 is operable to provide the derived weightings associated with the entities that compose, or are referenced by, the sets of logically-consistent sub-activities generated by activity decomposition engine 110 as described above. Ponderation engine 112 may be implemented using a knowledge-based system in conjunction with a neural network suitable for manipulation of weightings, such as a convolutional neural network, a recurrent neural network or a long short-term memory network.

The augmented data for the logically-consistent sub-activities is then provided to graph generation engine 114, which establishes the problem space boundaries between the start state and the goal and then arranges, in the form of a weighted graph, the network of possible paths through the logically-consistent sub-activities, summing the value weightings derived by the ponderation engine for each sub-activity in the graph, such that the value weightings can be taken into consideration during the decision-making process for establishing the relative preferabilities of the paths.

The graph generation engine may comprise a trained inferencing engine operable to analyse and determine the potential sub-activity relationships—for example, sub-activity A can be properly followed by sub-activity B or sub-activity C and sub-activity B may be followed either by sub-activity D or sub-activity E, while sub-activity C may be followed by sub-activity F and then sub-activity E, and so on. In each case, the graph generation engine 114 is operable to ensure that the sub-activity sequences of the paths maintain logical consistency of progress from start state to goal. In this way, the graph generation engine 114 is operable to train a model of personalised user outcomes of the sequences of sub-activities according to the fact-based and personal affect value weights.

The graph generation engine 114 provides its output to the scenario generation engine in the form of a model based on all paths and sub-activity nodes in the defined problem space, along with the summed value weightings of the sub-activities. Graph generation engine 114 may be implemented using a knowledge-based system in conjunction with a neural network suitable for manipulation of weightings, such as a convolutional neural network, a recurrent neural network, or a long short-term memory network.

The scenario generation engine 116 accepts this input model from the graph generation engine 114, and then proceeds to analyze the model representing the network of value-weighted and logically-consistent potential sub-activities connected by paths to select a best available scenario path to the activity goal according to the personalised user outcomes developed above. The decision-making process may be implemented, for example, by using a rules-based system, a pre-trained stochastic expert system, an autonomous or quasi-autonomous machine-learning and inferencing system, such as a deep learning neural network, or any combination of these technologies.

The scenario generation engine 116 provides its analysis of the model and details of the selected scenario and the process it has followed to decide on the selected scenario to feedback engine 118. Feedback engine 118 interacts with world context knowledge base 104 and personal digital memory 106 to provide augmentation information to update the state of world context knowledge and personal digital memory. For example, the selected scenario may require that the world context knowledge base 104 and personal digital memory 106 be updated to indicate that for a specific date, there is a potential booking—this needs to be “pencilled-in” to any planner information held in either world context knowledge base 104 and personal digital memory 106, so that the system is aware of a need to consider this to avoid any subsequent conflicts with other activities that may be in the process of being planned during the period before the scenario is enacted in reality.

Subsequently or simultaneously, the information about the selected scenario is passed from scenario generation engine 116 to the output channel 120 where it is formatted into a form suitable for output 122 to one or more entities outside the machine learning and inferencing system 100. Taking as an example, a planned dinner party at a restaurant, output channel 120 may format information for the scenario into a restaurant reservation, a calendar reminder for the user, and a set of personalised invitations to be sent to the guests. In another example, for a self-build project, the information may be formatted into a tools and materials list, a sequence chart of planned build activities, and a reminder that an official building permit is required before the work can begin.

Turning now to FIG. 2, there is shown a simplified representation of a world context knowledge acquisition arrangement 200, according to an implementation of the presently described technology.

World context knowledge acquisition 200 represents the ways in which the world context knowledge base 104 described above and shown in FIG. 1 acquires its information. World context knowledge base 104 may be trained either in a supervised mode, in which a human provides information over, for example, an interactive query interface 210, or by means of, for example, a direct provision of a bulk corpus of knowledge in the form of a pre-prepared data set. In another example, the world context knowledge base 104 may be provisioned with knowledge by means of direct inputs in response to autonomous learning queries. World context knowledge base 104 may further be provided with information from various parts of the knowledge held in the World Wide Web corpus 202, as well as in any relevant domain knowledge base 204 . . . . World context knowledge base 104 may be provided with sensor data via sensor input 208, which may be, for example, a weather station's data that might be relevant to planning an outdoor event.

World context knowledge acquisition may be implemented using a deep learning technology that may exploit a knowledge-based system in conjunction with a neural network suitable for derivation and classification of facts from a corpus, such as a convolutional neural network, a recurrent neural network, or a long short-term memory network.

World context knowledge base 104 may, in addition, be cooperable with a user's personal digital memory 106 (as described above and shown in FIG. 1) to enable it to derive general information from the specifics in the user's personal digital memory 106. In some implementations, where matters of personal privacy can be appropriately dealt with, world context knowledge base 104 may be cooperable with at least one other user's digital memory 206 . . . to derive general information from the specifics in the other user's personal digital memory. The interactions between world context knowledge base 104, personal digital memory 106, other user's digital memory 206, end the other information sources may be mediated by a human users, may be driven by a rules engine, or may comprise autonomous or quasi-autonomous knowledge-seeking.

World context knowledge base 104 may, in addition, be augmented or modified with feedback 212, as shown above in FIG. 1, permitting updating of world context information according to changes made during an activity planning process. In one example, feedback 212 may block out a diary space in a calendar held in world context knowledge base 104 for a potential future activity that is being planned, and this change will be taken into account in further, subsequent planning activities.

Turning now to FIG. 3, there is shown a simplified representation of a method 300 of operating a machine learning and inferencing system operable to generate a personalised activity plan according to an implementation of the present technology.

The method begins at START 302 and at 304, an activity descriptor is received as input. The activity descriptor may be received in a natural language form or in some formal schema, and is used at 306 to establish at least one activity goal. At 308, an activity decomposition engine, co-operable with a trained world context knowledge base and a trained personal digital memory store comprising personal affect values for a user, is used to decompose an activity into a network of logically-consistent potential sub-activities connected by paths converging at the activity goal. At 310, a ponderation engine, co-operable with the world context knowledge base and the personal digital memory store, assigns fact-based and personal affect value weights to the logically-consistent potential sub-activities according to a value scheme derived from the world context knowledge base and the personal digital memory store.

At 312 a graph generation engine, responsive to the activity decomposition engine and the ponderation engine, generates a multi-layer weighted graph operable to train a model of personalised user outcomes of the sub-activities according to the fact-based and personal affect value weights. At 314, a scenario generation engine, co-operable with the graph generation engine, analyzes the network of logically-consistent potential sub-activities connected by paths to determine a selected scenario path to the activity goal according to at least the model of personalised user outcomes. To maintain ongoing augmentation and refinement of the world context knowledge and personal digital memory, at 316, a feedback engine is used to apply the learning accumulated during the process and used by the scenario generation engine to the world context knowledge base and/or the personal digital memory store. The output channel, at 318, prepares the scenario for output in the form of a personalised activity plan comprising recommended actions to implement the selected scenario path, and the process completes at END 320. As will be immediately clear to one of skill in the art, END step 320 merely completes this iteration of the process, and the process may be reiterated one or more times by returning to START 302—for example the user may elect not to accept the selected scenario because one or more of the recommended actions is undesirable, in which case, some additional input may be provided to the process at a further instance of input receipt step 304 and the process performed on the basis of the changed parameters.

The present technique thus relates to an apparatus, method and computer program for developing a personal generative AI technology which can perform the human neurocognitive functions of task planning, sub-activity organization, time management, priority evaluation and task-related problem-solving with a degree of autonomy and creativity. Such a personal generative machine learning and inferencing technology is operable to perform complex executive functioning tasks such as planning and organizing large events taking into account world context and domain-specific knowledge, as well as the user's personal context, both in terms of factual knowledge and of affect values.

As will be clear to one skilled in the art, the machine learning and inferencing system according to the present technology comprises a set of cooperating elements, each of which can exploit stored knowledge derived from external sources and assembled in knowledge-based systems along with knowledge generated by the use of artificial intelligence technologies, such as generative large language model artificial intelligence or one or more of the available types of artificial neural network, such as convolutional neural networks, recurrent neural networks, long short-term memory networks and the like.

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, implementations of the present technique may take the form of a computer program product embodied in a non-transitory computer readable medium having computer readable program code embodied thereon. The computer readable medium may be a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present technique may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A machine learning and inferencing system operable to generate a personalised activity plan comprising:
a trained world context knowledge base;
a trained personal digital memory store comprising personal affect values for a user;
a goal engine to establish at least one activity goal derived from an input activity descriptor;
an activity decomposition engine co-operable with the world context knowledge base and the personal digital memory store to decompose an activity into a network of logically-consistent potential sub-activities connected by paths converging at the activity goal;
a ponderation engine co-operable with the world context knowledge base and the personal digital memory store to assign fact-based and personal affect value weights to the logically-consistent potential sub-activities according to a value scheme derived from the world context knowledge base and the personal digital memory store;
a graph generation engine responsive to the activity decomposition engine and the ponderation engine to generate a multi-layer weighted graph operable to train a model of personalised user outcomes of the sub-activities according to the fact-based and personal affect value weights;
a scenario generation engine co-operable with the graph generation engine to analyze the network of logically-consistent potential sub-activities connected by paths to determine a selected scenario path to the activity goal according to at least the model of personalised user outcomes;
a feedback engine to apply learning from the scenario generation engine to the world context knowledge base and/or the personal digital memory store; and
an output channel to output a personalised activity plan comprising recommended actions to implement the selected scenario path.

2. The machine learning and inferencing system according to claim 1, wherein the world context knowledge base comprises at least one domain knowledge base.

3. The machine learning and inferencing system according to claim 1, wherein the world context knowledge base comprises an active database operable to detect at least one anomaly and to query at least one data source for data to resolve the anomaly.

4. The machine learning and inferencing system according to claim 3, wherein the querying the data source comprises using a joint embedding predictive architecture.

5. The machine learning and inferencing system according to claim 1, wherein the world context knowledge base is operable to query a peer system to acquire additional knowledge.

6. The machine learning and inferencing system according to claim 1, wherein the personal digital memory store is operable to query a peer digital memory store to acquire additional knowledge.

7. The machine learning and inferencing system according to claim 1, comprising at least one neural network.

8. The machine learning and inferencing system according to claim 7, wherein the at least one neural network comprises a long short-term memory network.

9. A method of operating a machine learning and inferencing system operable to generate a personalised activity plan comprising:
establishing at least one activity goal derived from an input activity descriptor;
operating an activity decomposition engine co-operable with a trained world context knowledge base and a trained personal digital memory store comprising personal affect values for a user to decompose an activity into a network of logically-consistent potential sub-activities connected by paths converging at the activity goal;
operating a ponderation engine co-operable with the world context knowledge base and the personal digital memory store to assign fact-based and personal affect value weights to the logically-consistent potential sub-activities according to a value scheme derived from the world context knowledge base and the personal digital memory store;
generating, by a graph generation engine responsive to the activity decomposition engine and the ponderation engine, a multi-layer weighted graph operable to train a model of personalised user outcomes of the sub-activities according to the fact-based and personal affect value weights;
operating a scenario generation engine co-operable with the graph generation engine to analyze the network of logically-consistent potential sub-activities connected by paths to determine a selected scenario path to the activity goal according to at least the model of personalised user outcomes;
operating a feedback engine to apply learning from the scenario generation engine to the world context knowledge base and/or the personal digital memory store; and
emitting, by way of an output channel, a personalised activity plan comprising recommended actions to implement the selected scenario path.

10. The method according to claim 9, wherein operating any one of the engines co-operable with the world context knowledge base comprises operating a domain knowledge base.

11. The method according to claim 9, wherein operating any one of the engines co-operable with the world context knowledge base comprises detecting an anomaly and querying at least one data source for data to resolve the anomaly.

12. The method according to claim 11, wherein the querying at least one data source comprises using a joint embedding predictive architecture.

13. The method according to claim 9, wherein operating any one of the engines co-operable with the world context knowledge base comprises querying a peer system to acquire additional knowledge.

14. The method according to claim 9, wherein operating any one of the engines co-operable with the personal digital memory store comprises querying a peer digital memory store to acquire additional knowledge.

15. The method according to claim 9, wherein operating any one of the engines comprises activating a neural network.

16. The method according to claim 15, wherein activating a neural network comprises activating a long short-term memory network.

17. A computer program comprising computer program code to, when loaded into a computer and executed thereon, cause said computer to perform all the steps of the method according to claim 9.
